(19) United States
(12) Patent Application Publication
(10) Pub. No.: US 2007/0236797 A1
(43) Pub. Date: Oct. 11, 2007

(54) Wavelength dispersion compensation device

(75) Inventors: Kohei Shibata, Kawasaki (JP); Nobuhiro Fukushima, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/506,941

(22) Filed: Aug. 21, 2006

(30) Foreign Application Priority Data
Apr. 7, 2006 (JP) 2006-106497

(51) Int. Cl. G02B 1/10

(52) U.S. Cl. 359/584; 359/578

(57) ABSTRACT

A wavelength dispersion compensation device includes an etalon 100 having a slab shape. Reflective films are formed on each side of the etalon 100. The reflective films respectively have predetermined reflectance. Reflectance of one of the reflective films differs according to a light incident angle by using a portion of light within a wavelength range to be used with which a filter characteristic in which transmittance rapidly changes is obtained.

### CROSS-REFERENCE TO RELATED APPLICATIONS

This application is based upon and claims the benefit of priority from the prior Japanese Patent Application No. 2006-106497, filed on Apr. 7, 2006, the entire contents of which are incorporated herein by reference.

### BACKGROUND OF THE INVENTION

1. Field of the Invention

The present invention relates a dispersion compensation device used in optical communication.

2. Description of the Related Art

When an optical signal pulse transmission is performed using an optical fiber, a speed of transmission through the optical fiber differs depending on a light wavelength. Therefore, as a transmission distance increases, a signal pulse waveform flattens. This phenomenon is referred to as wavelength dispersion. When the wavelength dispersion is generated, a reception level is significantly degraded. For example, when a single mode fiber (SMF) is used, a wavelength dispersion of −15 to −16 ps/nm·km is generated near a wavelength of 1.55 micrometers (μm) that is often used in optical pulse communication. In wavelength dispersion compensation (referred to as dispersion compensation), wavelength dispersion of the same amount as the wavelength dispersion generated when the optical fiber is used is conversely added.

Currently, a dispersion compensating fiber (DCF) is the most common optical fiber used to perform dispersion compensation. The DCF is designed to generate dispersion (structure dispersion) that is an opposite of material dispersion of a fiber material. The opposing dispersion is generated by a specific refractive index distribution. In total, the DCF generates dispersion that is an opposite of dispersion generated in an ordinary SMF (dispersion compensation of about 5 to 10 times the amount generated in an SMF of a same length). The DCF is connected to the SMF at a relay station, and a total dispersion is zero (cancelled).

In recent years, in response to increasing communication demands, further increase in capacity is required for large capacity transmission using wavelength division multiplexing (WDM). In addition to reduction in intervals between wavelength multiplexing, increase in communication speed is required (for example, 40 Gb/s). As a result, wavelength dispersion tolerance decreases when relay distances are the same. Temperature fluctuations generated when the wavelength dispersion is generated using SMF also requires compensation. The temperature fluctuations are conventionally not a problem. An actualization of a wavelength dispersion compensator that can change the compensation amount is required, in addition to the conventional fixed type DCF.

Specifically, a wavelength division type optical dispersion compensator using an etalon (for example, Japanese Patent Laid-open Publication Nos. 2002-267834 and 2003-195192). A tunable optical dispersion compensator using a reflective etalon is disclosed as a reflection type wavelength dispersion compensator (for example, Japanese Patent Laid-open Publication No. 2004-191521).

FIG. 7A is a schematic of a conventional tunable optical dispersion compensator. A tunable optical dispersion compensator 1000 includes an etalon 1010 and a mirror 1020. The etalon 1010 is a Gires-Tournois (GT) etalon. A reflective film 1011 is formed on one side of the etalon 1010. The reflective film 1011 has reflectance that continuously differs along a certain direction. A reflective film 1012 is formed on another side of the etalon 1010. The reflective film 1012 has approximately 100% reflectance. The mirror 1020 has a high-reflectance reflective film 1021. The mirror 1020 is placed at a slight angle to the etalon 1010. A beam emitted from a collimator 1030 is reflected by the mirror 1020, resonated by the etalon 1010, and enters a collimator 1040.

FIG. 7B is a perspective view of the conventional tunable optical dispersion compensator. As shown in FIG. 7B, the etalon 1010 is attached to a slide rail 1061 on a linear slide 1060. The etalon 1010 slides along a direction X. A reflectance of the reflective film 1011 continuously changes along the direction X. A dispersion compensation amount can be changed by the sliding of the etalon 1010.

However, the reflective film 1011 included in the etalon 1010 has low manufacturability and low uniformity. FIG. 8 is a schematic for illustrating a method of forming the reflective film. The reflective film 1011 on the etalon substrate 1010 is formed, for example, by layer formation. A low refractive index material and a high refractive index material are alternately layered as vapor-deposition materials. When forming the reflective film 1011, a deposition mask 1050 is slid in the direction X so that an area of each of layers 1011a to 1011n differs along the direction X. While forming the reflective film 1011, it is necessary to replace the deposition mask 1050 with a deposition mask that matches a mask area each time the deposition material is changed, or to slide the etalon substrate 1010 in the direction X. Thus, the reflective film takes time and labor to be formed, thereby inhibiting improvement in productivity.

Furthermore, because the deposition mask 1050 is used, a vapor-deposition material tends to leak onto a back surface of the deposition mask 1050. Therefore, it is difficult to form the layer in a uniform thickness, and special measures are required to be taken to solve the leakage. As a result, the etalon, which is a main component of the tunable optical dispersion compensator, becomes costly. In addition, it becomes difficult to acquire desired characteristics regarding the dispersion compensation amount of the tunable optical dispersion compensator.

### SUMMARY OF THE INVENTION

It is an object of the present invention to at least solve the above problems in the conventional technologies.

A wavelength dispersion compensation device according to one aspect of the present invention includes an etalon in a slab shape having at least two surfaces opposite to each other. The etalon includes reflective films formed on the surfaces respectively. One of the reflective films has incident angle dependence in which reflectance differs depending on an incident angle of the light, and has a filter characteristic in which the reflectance abruptly changes in a range of wavelength of light to be used for the wavelength dispersion compensation.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1A is a schematic of an etalon used in a wavelength dispersion compensation device according to an embodiment of the present invention;

FIG. 1B is a plot of a group delay characteristic of the etalon shown in FIG. 1A;

FIG. 1C is a plot of a group delay characteristic of the etalon shown in FIG. 1A;

FIG. 2 is a plot of a reflection characteristic of reflective films on the etalon;

FIG. 3 is a schematic for explaining a method of forming the reflective films;

FIG. 4A is a plot of a group delay characteristic when the etalon having the reflective films shown in FIG. 2 is configured in multistage;

FIG. 4B is a plot of a transmission characteristic when the etalon having the reflective films shown in FIG. 2 is configured in multistage;

FIG. 5 is a schematic of a wavelength dispersion compensating module;

FIG. 6 is a schematic of the etalon configured in multistage;

FIG. 7A is a schematic of a conventional tunable optical dispersion compensator;

FIG. 7B is a perspective view of the conventional tunable optical dispersion compensator; and

FIG. 8 is a schematic for explaining a method of forming a reflective film on the etalon.

### DETAILED DESCRIPTION OF THE PREFERRED EMBODIMENTS

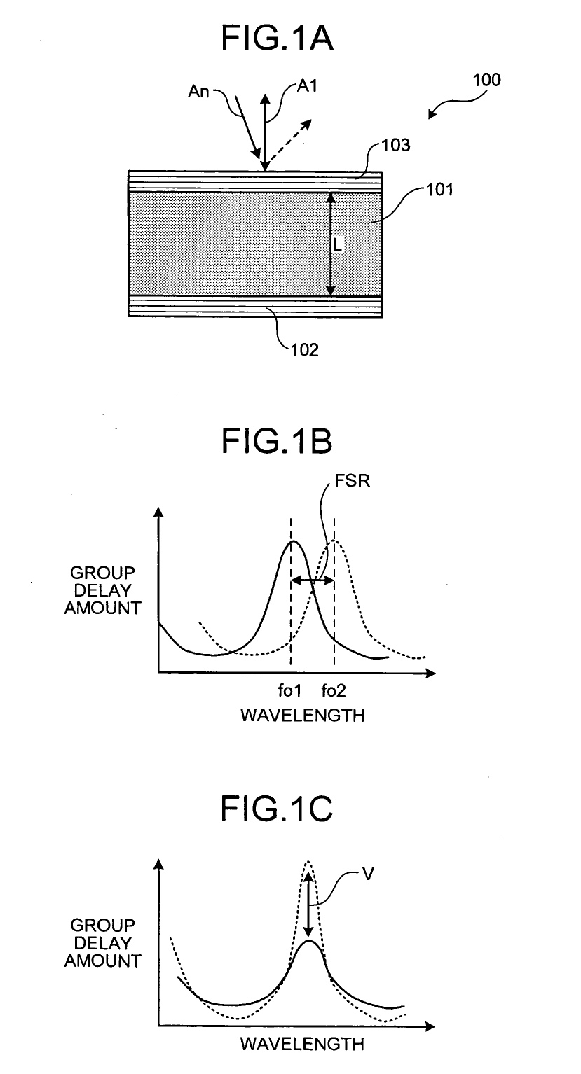

Exemplary embodiments of the present invention will be explained in detail below with reference to the accompanying drawings. FIG. 1A is a schematic of an etalon used in a wavelength dispersion compensation device according to an embodiment of the present invention. A reflective etalon 100 includes a slab-shaped etalon substrate 101 and two reflective films 102 and 103. The etalon substrate 101 has thickness L. The two reflective films 102 and 103 are formed on opposite sides of the etalon substrate 101. One reflective film 102 has a mirror surface or a high-reflection coating. A reflectance of the reflective film 102 is set to almost 100%. Another reflective film 103 is a light incident side. A reflectance of the reflective film 103 is lower than that of the other reflective film 102. In the etalon 100, a light incident on the reflective film 103 is reflected by the reflective film 102 and emitted from the reflective film 103.

FIG. 1B is a plot of a group delay characteristic of the etalon 100. A horizontal axis indicates wavelength. A vertical axis indicates a group delay amount. A central wavelength interval (free spectral range (FSR)) and a center wavelength (fo1, fo2, . . . ) of the etalon 100 are set based on an optical distance between the two reflective films 102 and 103 (cavity length of the etalon substrate 101, thickness L shown in FIG. 1A).

FIG. 1C is a plot of a group delay characteristic of the etalon 100. A group delay amount (finesse V) is set based on the reflectance of the reflective film 103. The group delay amount determines a dispersion compensation amount. The reflective film 103 has a low reflectance.

A light incident angle of light incident on the etalon 100 continuously changes. Light Al has a perpendicular incident angle to the reflective film 103. Light An has a predetermined angle. By varying the light incident angle, the group delay amount is varied, thereby changing the dispersion compensation amount.

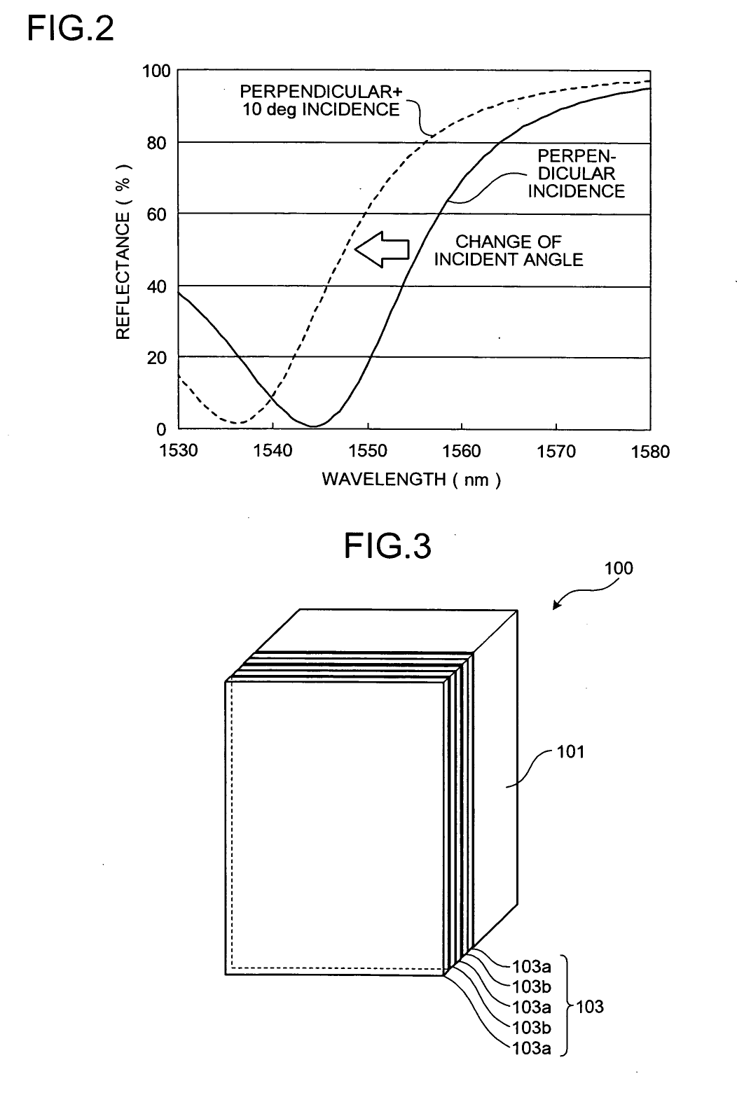

FIG. 2 is a plot of a reflection characteristic of the reflective film 103. The horizontal axis indicates the wavelength. The vertical axis indicates the reflectance. The reflective film 103 is set and formed so as to have a following characteristic. The reflectance of the reflective film 103 changes rapidly within a wavelength range to be used. As shown in FIG. 2, when the light incident angle to the reflective film 103 is perpendicular near a wavelength of 1550 nanometers (nm), the reflectance is 20%. When the light incident angle to the reflective film 103 is 10 degrees (perpendicular+10 deg incidence), the reflectance is 65%.

Therefore, when the light incident angle is changed by 10 degrees, the reflectance can be changed within a range of 20% to 65%. A characteristic of the reflective film 103, such as the above, can be actualized by setting the wavelength range to be used, to a portion (edge portion) at which filter characteristics of an optical band pass filter (BPF) and an optical band rejection filter (BRF) rapidly change. In addition, a state of changes in the reflectance with respect to the wavelength (a change rate and an angle of a characteristic line (slope)) can be arbitrarily set by adjusting the total number of layers in the reflective film 103 and thickness of each layer.

In the reflectance characteristic shown in FIG. 2, the reflectance has a continuous, rather than a gradual, wavelength dependence. The characteristic indicates that a generated group delay differs (changes) depending on wavelength. Therefore, the dispersion compensation amount can be continuously changed in a wavelength direction (every time the wavelength differs).

FIG. 3 is a schematic for explaining a method of forming the reflective film 103. The reflective film 103 is formed, for example, by alternately layering a film 103a of a low refractive index material and a film 103b of a high refractive index material by vapor-deposition. The films 103a and 103b are both formed on one side of the etalon substrate 101. The films 103a and 103b may be formed on the entire surface. Thus, a reflective film 103 having reflectance dependent on an incident angle can be formed. Each layer of the reflective film 103 can be easily formed, for example, to an arbitrary thickness by merely controlling a vapor-deposition time. A vapor-deposition mask is not required. Therefore, manufacturability can be improved, uniformity of the films can be enhanced, and characteristics for desired dispersion compensation amount can be easily acquired.

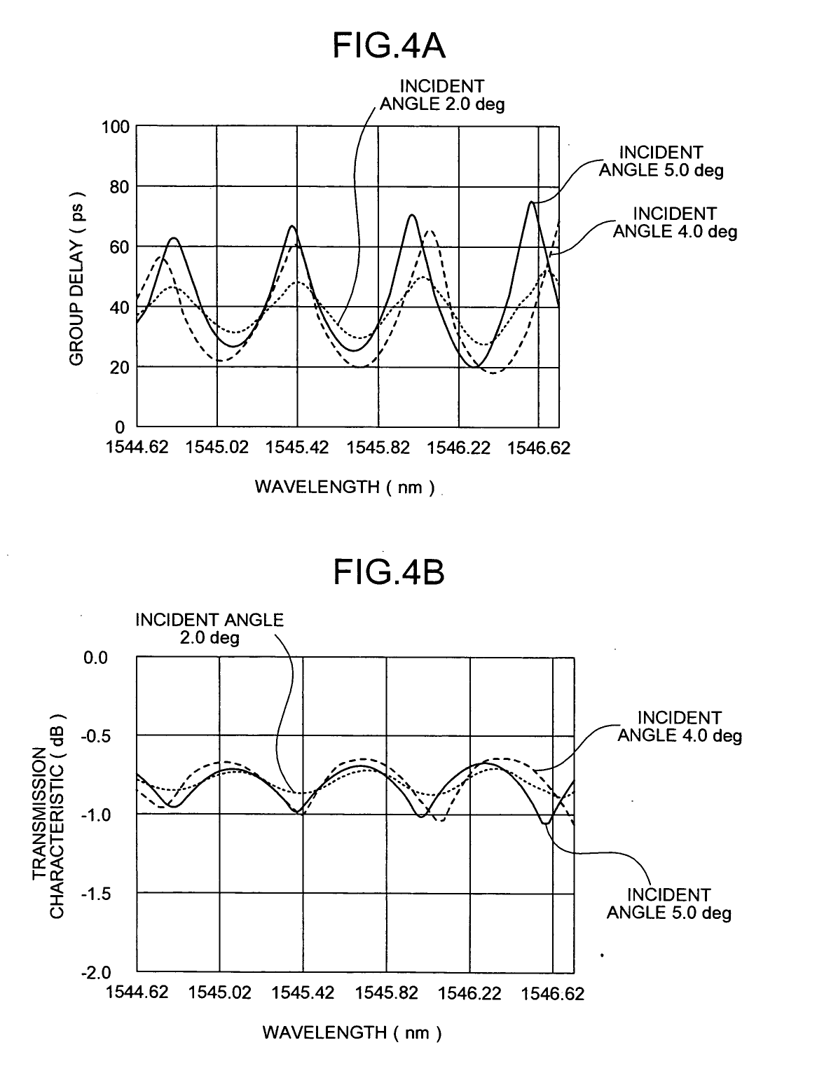

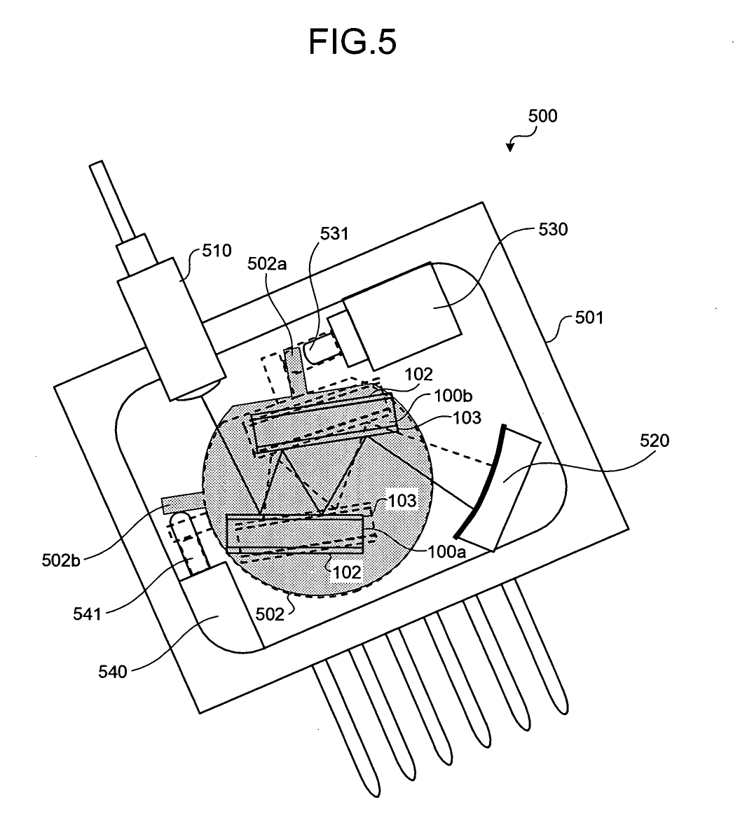

FIG. 4A is a plot of a group delay characteristic when the etalon having the reflective films shown in FIG. 2 is configured in multistage. FIG. 4B is a plot of a transmission characteristic when the etalon having the reflective films shown in FIG. 2 is configured in multistage. Respective characteristics when a light passes through the etalon in three stages. The etalon 100 is designed so that the characteristic line differs in each stage. The light can pass through the etalon 100 in each stage. Therefore, an effective bandwidth (wavelength range) on which dispersion compensation is performed by each channel, stipulated in an international telecommunication union (ITU) grid, can be increased.

FIG. 5 is a schematic of a wavelength dispersion compensating module 500. The wavelength dispersion compensating module 500 includes two units of the etalons 100 described above. Light is incident on and emitted from one optical port. A collimator 510 is placed in one area of a housing 501. The collimator 510 is on an end of an optical fiber. The two etalons 100 (100a and 100b) are placed within the housing 501. Light emitted from the collimator 510 is incident on the etalons 100a and 100b. The etalons 100a and 100b are placed so that the respective reflective films 103 face each other. A placement angle of the etalons 100a and 100b is substantially parallel. Alternatively, one of the etalons 100 can be placed at an angle to the other one of the etalons 100 as shown in FIG. 5.

As shown in the diagram, the light emitted from the collimator 510 passes through the etalon 100a and the etalon 100b, and then, the light is reflected by a reflective body 520 to be returned. A returning path is sequentially returned through the etalon 100b and then the etalon 100a, and the light is incident on the collimator 510. The wavelength dispersion compensation module 500 has four stages structure in total in both ways.

The two etalons 100a and 100b are arranged on a stage 502. The stage 502 is rotatable about a rotation center of the stage 502 that is an approximately intermediate position between the two etalons 100a and 100b. The stage 502 is rotated by a rotation mechanism, and functions as an incident angle changing unit to change the incident angle of the light incident on the etalon 100a. The light is emitted from the collimator 510 that is an optical port. The rotation mechanism includes an extruding mechanism 530 and a biasing mechanism 540. The extruding mechanism 530 and the biasing mechanism 540 are provided beside the stage 502. The extruding mechanism 530 includes a combination of a stepping motor and a gear, or a piezo element and the like. In the extruding mechanism 530, a differential piece 531 extrudes a protrusion piece 502a of the stage 502 and rotates the stage 502. The biasing mechanism 540 includes a return spring and generates a bias force in a direction opposite of an extrusion direction of the extruding mechanism 530. The bias force is transmitted to a protrusion piece 502b of the stage 502, via a differential piece 541.

According to the wavelength dispersion compensating module 500, the stage 502 is rotated by the extruding mechanism 530 being operated. Due to the rotation, the incident angle of the light emitted from the collimator 510 to the two etalons 100a and 100b can be changed. For example, as shown in FIG. 4A and FIG. 4B, changes in the group delay frequency characteristic and the transmission characteristic corresponding to the light incident angle can be achieved (however, because the configuration shown in FIG. 5 is the four-stage structure, the characteristics thereof differ from that of the three-stage structure shown in FIG. 4A and FIG. 4B).

According to the configuration shown in FIG. 5, the light can be incident on and emitted from a single optical port. Therefore, the number of components in the wavelength dispersion compensating module 500 can be reduced and the wavelength dispersion compensating module 500 can be downsized. Furthermore, the wavelength dispersion compensating module 500 can be manufactured at a low cost. The configuration of the wavelength dispersion compensating module 500 is not limited to that described above. A light incident port and a light emitting port can be separately provided. In addition, as another configuration example of the rotation mechanism, a motor with a gear can be placed on the rotation center of the stage 502 to rotate the stage 502. Other than the configuration in which the stage 502 on which the etalon 100 is mounted is rotated, the light incident angle to the etalon 100 can be changed by the etalon 100 side being held stationary and the angle of the light incident port being changed. The light incident angle to the etalon 100 can be relatively changed. Although the wavelength dispersion compensating module 500 has the four-stage structure, the configuration is not limited thereto. The wavelength dispersion compensating module 500 can have multiple stages and an arbitrary dispersion compensation amount can be attained.

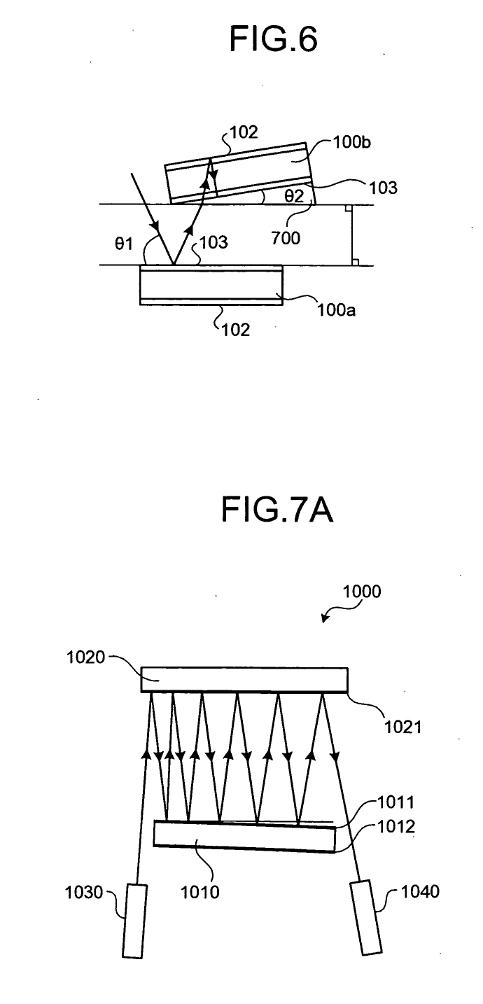

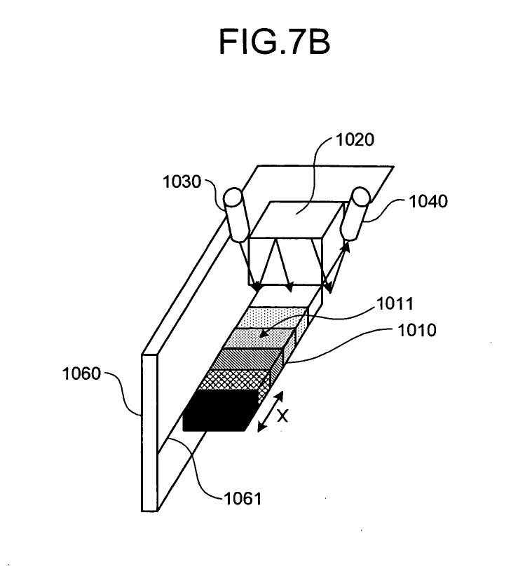

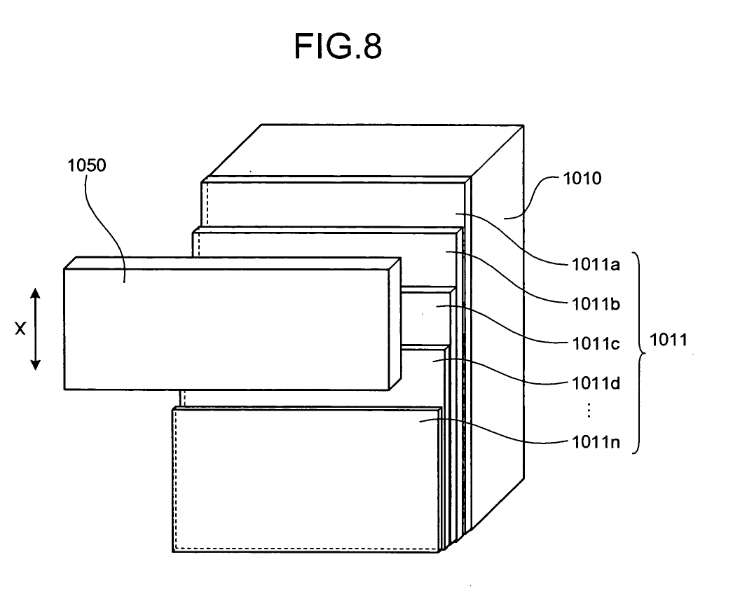

FIG. 6 is a schematic of an etalon configured in multistage. The placement of the two etalons 100a and 100b is the same as that in FIG. 5. A light refracting component 700, for example, a prism, is placed on a surface of the reflective film 103 of the etalon 100b. The light refracting component 700 has a tilt angle θ2 so that the incident surface is parallel to the surface of the reflective film 103 of the etalon 100a. In the example shown in FIG. 6, the tilt angle θ2 of the light refracting component 700 is almost equal to a light incident angle θ1 to the etalon 100a. As a result, the incident angle of the light incident on the etalon 100b can be adjusted depending on the tilt angle θ2.

According to the configuration shown in FIG. 6, the same etalon can be applied to the etalons 100a and 100b opposing to each other to form the multi-stage configuration. In addition, it is possible to configure the etalon such that the etalon 100a and the etalon 100b have different compensation amounts, as a slope characteristic (see FIG. 4A and FIG. 4B) when the etalon is configured in multistage. The compensation amount between each stage can be varied by a use of the etalons 100a and 100b, and dispersion compensation of all stages combined can be performed. Furthermore, changes in wavelength interval difference (FSR) can be suppressed, even when there is a plurality of stages.

According to the embodiment explained above, the reflective film having a different reflectance depending on the light incident angle can be easily formed. Therefore, the manufacturability of the etalon can be improved, and the wavelength dispersion compensation device can be manufactured at a low cost. Furthermore, the reflectance can be made wavelength dependent. As a result, a wavelength dispersion compensation device that corresponds to required dispersion compensation characteristics can be manufactured.

The etalon substrate 101 can be formed with silicon or zinc selenide that are high-refraction materials. By a use of the high-refraction material, the changes in the wavelength interval caused by the changes in the light incident angle can be suppressed. Therefore, a variable range (number of wavelengths) can be increased.

According to the embodiments described above, it is possible to obtain required dispersion compensation amount with ease. Moreover, it is possible to manufacture a wavelength dispersion compensation device easily at low cost.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A wavelength dispersion compensation device comprising an etalon in a slab shape having at least two surfaces opposite to each other, and including reflective films formed on the surfaces respectively, wherein
one of the reflective films has incident angle dependence in which reflectance differs depending on an incident angle of the light, and has a filter characteristic in which the reflectance abruptly changes in a range of wavelength of light to be used for the wavelength dispersion compensation.

2. The wavelength dispersion compensation device according to claim 1, wherein a rate of change of the reflectance in the range is set according to a desired wavelength dispersion characteristic.

3. The wavelength dispersion compensation device according to claim 1, wherein
one of the surfaces is a light incident surface, and
the one of the reflective films is a multilayer film formed on the light incident surface with a material having a high refraction index and a material having a low refraction index.

4. The wavelength dispersion compensation device according to claim 3, wherein number of layers formed with each of the material having a high refraction index and the material having a low refraction index is determined so that reflectance dependent on the incident angle is obtained.

5. The wavelength dispersion compensation device according to claim 3, wherein thickness of layers formed with each of the material having a high refraction index and the material having a low refraction index is determined so that reflectance dependent on the incident angle is obtained.

6. The wavelength dispersion compensation device according to claim 1, wherein
the etalon is arranged in plurality so as to oppose to each other, and
the wavelength dispersion compensation device further comprising:
an incident port from which the light is incident on one of the etalons;
an emitting port from which the incident light is emitted via the etalons; and
an angle changing unit configured to change an incident angle of the incident light.

7. The wavelength dispersion compensation device according to claim 5, further comprising a reflective body to replicate a path of the incident light, the path passing through the etalons, wherein
the incident port and the emitting port are one common optical port.

8. The wavelength dispersion compensation device according to claim 6, wherein the angle changing unit includes a rotating unit configured to rotate a stage on which the etalons are mounted.

9. The wavelength dispersion compensation device according to claim 6, wherein
the etalons are arranged such that the incident surface of each of the etalons face each other having a predetermined tilt angle to each other, and
one of the etalons includes a light refracting member to adjust the light incident angle to the light incident surface according to the desired wavelength dispersion characteristic.

10. The wavelength dispersion compensation device according to claim 1, wherein a substrate of the etalon is formed with a high-refraction material.

11. The wavelength dispersion compensation device according to claim 10, wherein the high-refraction material includes silicon

12. The wavelength dispersion compensation device according to claim 10, wherein the high-refraction material includes zinc selenide.

13. The wavelength dispersion compensation device according to claim 3, wherein the multilayer film is formed on substantially entire surface of the light incident surface.
